(19) United States
(12) Patent Application Publication
(10) Pub. No.: US 2025/0205631 A1
(43) Pub. Date: Jun. 26, 2025

(54) CONTINUOUS DIRECT AIR CAPTURE SYSTEM WITH A LOW DIFFERENTIAL PRESSURE AND OPERATING METHOD

(71) Applicant: KOREA INSTITUTE OF ENERGY RESEARCH, Daejeon (KR)

(72) Inventors: Yu Ri Lee, Daejeon (KR); Hyunuk Kim, Daejeon (KR); Gyoung-tae Jin, Daejeon (KR); Young Cheol Park, Daejeon (KR); Sung-ho Jo, Daejeon (KR); Jae Young Kim, Daejeon (KR); Dong-Ho Lee, Daejeon (KR); Daewook Kim, Daejeon (KR); Jae-hyeon Park, Daejeon (KR); Seung-yong Lee, Daejeon (KR); Dong-Kyu Moon, Daejeon (KR)

(73) Assignee: KOREA INSTITUTE OF ENERGY RESEARCH, Daejeon (KR)

(21) Appl. No.: 18/986,386

(22) Filed: Dec. 18, 2024

(30) Foreign Application Priority Data
Dec. 26, 2023 (KR) 10-2023-0190750

(51) Int. Cl. B01D 53/04

(52) U.S. Cl. CPC B01D 53/0423; B01D 53/0438; B01D 53/0446; B01D 53/0454; B01D 2257/504; B01D 2258/06; B01D 2259/4009

(57) ABSTRACT

The present disclosure relates to a continuous direct air capture system with a low differential pressure and operating method thereof, more particularly to, as a direct air capture system, a continuous direct air capture system with a low differential pressure including: an adsorption unit including a housing having an inlet part for introducing external air and an outlet part for discharging carbon dioxide-removed air, and a plurality of adsorbent modules installed within the housing and composed of carbon dioxide adsorbents, wherein the adsorption unit is connected in plurality, and the adsorption unit sequentially undergoes adsorption mode and regeneration mode and always operates in adsorption mode in a set number of adsorption units; a suction valve provided at the inlet part for introducing external air, and an outlet valve provided at the outlet part for exhausting the gas passed through the adsorbent modules; and a controller for controlling the suction valve and the outlet valve according to the adsorption mode and the regeneration modes, respectively.

### CORSS-REFERENCE TO RELATED APPLICATIONS

This application claims priority to and the benefit of Korea Patent Application No. 10-2023-0190750 filed in the Korean Intellectual Property Office on Dec. 26, 2023, the contents of which are incorporated herein by reference in their entirety.

### BACKGROUND

### Technical Field

The present disclosure relates to a continuous direct air capture system with a low differential pressure and operating method thereof.

### Related Art

To maintain the global temperature rise below 1.5 degrees Celsius, negative carbon emission technologies are necessary, and direct air capture (DAC) technology is one option.

The limitations of existing Carbon Capture and Storage (CCS) technology for capturing CO₂ from a large-scale CO₂ source with high CO₂ concentrations are supposed to be overcome and a paradigm shift toward small-scale, distributed CO₂ capture is necessary. It has been evaluated as a technology that is capable of capturing CO₂ from the atmosphere anytime and anywhere and removing 36 to 120 billion tons of CO₂ annually worldwide (NASEM report, 2018).

The high cost of direct air capture of CO₂ from the atmosphere has been a concern, but recent reports indicate that capture costs of less than $100 per ton of CO₂ are now possible.

Furthermore, numerous products can be produced with carbon captured from the air (tremendous economic value can be achieved by utilizing one of the major climate pollutants currently discarded as waste).

Additionally, the demand for technologies that remove CO₂ from a portion of the circulating air in Heating, Ventilation, and Air Conditioning (HVAC) systems is increasing.

The current operation of these systems involves absorbing carbon dioxide for a specific duration (working hours), and then releasing the absorbed carbon dioxide into the air and discharging it outside during lunch break or after work.

In this carbon dioxide capture and recovery technology, a low differential pressure process is the key. In other word, it is crucial to reduce the differential pressure generated as passing through the adsorbent module. A conventional method to mitigate the differential pressure is to increase the particle size of the adsorbent. However, in the case where the particle size becomes large, this method leads to a decrease in contact efficiency and adsorption performance.

Additionally, the carbon capture and utilization industry is expected to reach 800 billion dollars (approximately 800 trillion South Korean won) by 2030. Direct air capture technology enables countries without domestic oil reserves, currently facing high fuel costs, to produce fuels, potentially leveling fuel costs.

Indoor/atmospheric CO₂ capture devices combined with air purifiers has been introduced to the market as premium products for home, automotive, and classroom use.

However, conventional direct air capture devices utilize an alternating regeneration process for reactors rather than continuous processes, leading to the drawback of requiring additional energy consumption and heating/cooling time.

### RELATED ART DOCUMENT

### Patent Document

(Patent Document 1) Japanese Laid-Open Patent No. JP2012-520766
(Patent Document 2) Japanese Patent No. JP5932771
(Patent Document 3) Japanese Laid-Open Patent No. JP2016-26113
(Patent Document 4) Japanese Laid-Open Patent No. JP2020-32422

### DETAILED DESCRIPTION

### Technical Problem

Therefore, the present disclosure is contrived to address conventional issues as described above. According to an embodiment of the present disclosure, it aims to provide a continuous direct air capture system with a low differential pressure and operating method thereof. This system, a continuous direct air capture device with a low differential pressure, is capable of processing a large flow rate while minimizing pressure drop without interrupting the adsorbent reaction process, wherein the adsorbent or adsorbent module embedded in the adsorption tower follows the adsorbent regeneration cycle, enabling continuous cycle operation through adsorption, preheating, regeneration, and adsorption.

Further according to an embodiment of the present disclosure, it aims to provide a continuous direct air capture system with a low differential pressure and operating method thereof, which enables reducing a differential pressure without increasing the adsorbent particle size by installing a guide plate to lower the packing height and increase the surface, thereby lowering the flow rate passing through the adsorbent layer.

Yet further according to an embodiment of the present disclosure, multiple adsorption units are connected in an array and always operate in adsorption mode in a set number, thereby achieving continuous direct air operation.

Yet further, according to an embodiment of the present disclosure, it aims to provide a continuous direct air capture system with a low differential pressure and operating method thereof, wherein the number of adsorption units to be operated in adsorption mode within the installed space is determined, the time required for adsorption, heating, regeneration, and cooling is determined, and then the total number of adsorption units to match the number of adsorption units required to operate in the determined adsorption mode is determined.

Yet further, according to an embodiment of the present disclosure, it aims to provide it aims to provide a continuous direct air capture system with a low differential pressure and operating method thereof, which forms a closed-loop housing, and operates an adsorption unit located within the heating regeneration device in heating-regeneration mode by circulating this closed-loop through the heating regeneration device at a specific speed or rotating the housing, thereby enabling continuous operation without the need for multiple valves and valve control.

Meanwhile, technical objects to be achieved in the present invention are not limited to the aforementioned technical objects, and other technical objects, which are not mentioned above, will be apparently understood to a person having ordinary skill in the art from the following description.

### Technical Solution

According to a first aspect of the present disclosure, it can be achieved by, as a direct air capture system, a continuous direct air capture system with a low differential pressure including: an adsorption unit including a housing having an inlet part for introducing external air and an outlet part for discharging carbon dioxide-removed air, and a plurality of adsorbent modules installed within the housing and composed of carbon dioxide adsorbents, wherein the adsorption unit is connected in plurality, and the adsorption unit sequentially undergoes adsorption mode and regeneration mode and always operates in adsorption mode in a set number of adsorption units; a suction valve provided at the inlet part for introducing external air, and an outlet valve provided at the outlet part for exhausting gas passed through the adsorbent modules; and a controller for controlling the suction valve and the outlet valve according to adsorption mode and regeneration mode, respectively.

A second aspect of the present disclosure, it can be achieved by, as a direct air capture system, a continuous direct air capture system with a low differential pressure including an adsorption unit including a housing having an inlet part for introducing external air and an outlet part for discharging carbon dioxide-removed air, and a plurality of adsorbent modules installed within the housing and composed of carbon dioxide adsorbents, wherein the adsorption unit is configured in a tower shape with a width smaller than its length and height and a plurality of adsorption units are radially arranged around a central circle.

Further, the adsorption unit undergoes sequential cyclic process of adsorption mode, temperature increase mode, heating mode, regeneration mode, cooling mode, and adsorption mode.

Yet further, the suction valve and the outlet valve are 5-ways valves.

Yet further, the suction valve includes a suction connection port connected to the inlet part of the adsorption unit, an air inlet port for introducing air in adsorption mode, a preheating inlet port for introducing preheated gas in temperature increase mode, a heating inlet port for introducing heated gas in the heating mode, a regeneration inlet port for introducing regenerated gas, and a cooling inlet port for introducing coolant in cooling mode.

Yet further, the outlet valve includes an outlet connection port connected to the outlet part of the adsorption unit, an air outlet port for discharging air passed through an adsorption unit in adsorption mode, a preheating outlet port for discharging heated gas that has passed through an adsorption unit in temperature increase mode, a heating outlet port for discharging heated gas that has passed through an adsorption unit in heating mode, a regeneration outlet port for discharging regenerated gas that has passed through an adsorption unit in regeneration mode, and a cooling outlet port for discharging coolant passed through an adsorption unit.

Yet further, coolant discharged through the cooling outlet port is introduced into the preheating inlet port, and coolant discharged to the preheating outlet port is introduced into the cooling inlet port through a cooler.

Yet further, carbon dioxide enriched gas passed through the adsorption unit in regeneration mode is cooled, condensed, and stored.

Yet further, gas heated by a heater is introduced into the regeneration inlet port and gas that has passed through the adsorption unit and regenerated a carbon dioxide adsorbent is discharged and then a portion of the gas is heated by the heater and circulated, while the remaining portion is introduced into the heating inlet port to heat the adsorption unit operating in heating mode, and then discharged to the heating outlet port.

Yet further, carbon dioxide enriched gas passed the adsorption units in heating mode is cooled, condensed, and stored.

Yet further, in a regeneration zone, heated regeneration streams are uniformly distributed to the adsorbent module through an inlet header.

Yet further, in the regeneration zone, the adsorption unit is located within a tray. In the adsorption unit, the adsorbent modules are stacked in a stepped manner and a guide plate is included, connecting one corner of an adsorbent module to the opposite corner of another adsorbent modules located below the adsorbent module.

Yet further, the adsorbent modules are stacked in a stepped manner in an inlet zone where the regeneration stream is introduce during regeneration mode, with the width decreasing in direction of fluid flow.

Yet further, the adsorption unit has a tower-shaped structure where the width is smaller than the length and height, and a guide plate is included connecting one corner of the front side of the one adsorption unit to the opposite corner of the back side of another adsorption unit.

### Advantageous Effects

According to a continuous direct air capture system and operating method thereof in accordance of the embodiment of the present disclosure, there is an effect of being able to process a large flow rate while minimizing pressure drop without interrupting the adsorbent reaction process, wherein the adsorbent or adsorbent module embedded in the adsorption tower follows the adsorbent regeneration cycle, enabling continuous cycle operation through adsorption, preheating, regeneration, and adsorption.

Additionally, according to a continuous direct air capture system and operating method thereof in accordance of the embodiment of the present disclosure, there is an effect of being able to reduce a differential pressure without increasing the adsorbent particle size by installing a guide plate to lower the packing height and increase the surface, thereby lowering the flow rate passing through the adsorbent layer.

Further according to an embodiment of the present disclosure, multiple adsorption units are connected in an array and always operate in adsorption mode in a set number and thus there is an effect of being able to achieve continuous direct air operation.

Yet further, according to a continuous direct air capture system and operating method thereof in accordance of the embodiment of the present disclosure, the number of adsorption units to be operated in adsorption mode within the installed space may be determined, the time required for adsorption, heating, regeneration, and cooling may be determined, and then the total number of adsorption units to match the number of adsorption units required to operate in the determined adsorption mode may be determined.

Yet further, according to a continuous direct air capture system and operating method thereof in accordance of the embodiment of the present disclosure, there is an effect of being able to form a closed-loop housing, and to operate adsorption units located within the heating regeneration device in heating-regeneration mode by circulating this closed-loop through the heating regeneration device at a specific speed or rotating the housing, thereby enabling continuous operation without the need for multiple valves and valve control.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 is a front schematic view of an adsorption unit according to an embodiment of the present disclosure,

FIG. 2 is a configuration view of an adsorption unit in a tray according to an embodiment of the present disclosure,

FIG. 3A and FIG. 3B are configuration views of an adsorption unit applied with a header according to an embodiment of the present disclosure,

FIG. 4 is a configuration view of a step-type adsorption unit according to an embodiment of the present disclosure,

FIG. 5A to FIG. 5C are perspective and plan views of a tower-type adsorption unit according to an embodiment of the present disclosure,

FIG. 6 is a conceptual view of an adsorption unit according to an embodiment of the present disclosure,

FIG. 7 is a perspective view and a plan view of a continuous direct air capture system with a low differential pressure according to an embodiment of the present disclosure,

FIG. 8 is a configuration view of a continuous direct air capture system with a low differential pressure according to an embodiment of the present disclosure,

FIG. 9 is a configuration view of an operating method of a continuous direct air capture system with a low differential pressure according to an embodiment of the present disclosure,

FIG. 10A is a configuration view of an adsorption unit in adsorption mode A according to an embodiment of the present disclosure,

FIG. 10B is a configuration view of an adsorption unit in temperature increase mode H1 according to an embodiment of the present disclosure,

FIG. 10C is a configuration view of an adsorption unit in heating mode H according to an embodiment of the present disclosure,

FIG. 10D is a configuration view of an adsorption unit in regeneration mode (R) according to an embodiment of the present disclosure,

FIG. 10E is a configuration view of an adsorption unit in cooling mode C according to an embodiment of the present disclosure,

FIG. 10F is a connection configuration view of an adsorption unit in regeneration mode R and an adsorption unit in heating mode H,

FIG. 10G is a connection configuration view of an adsorption unit in cooling mode C and an adsorption unit in temperature increase mode H1, and

FIG. 11A to FIG. 11C are plan views of a tower type continuous direct air capture system with a low differential pressure according to an embodiment of the present disclosure.

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art.

In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be reformed. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

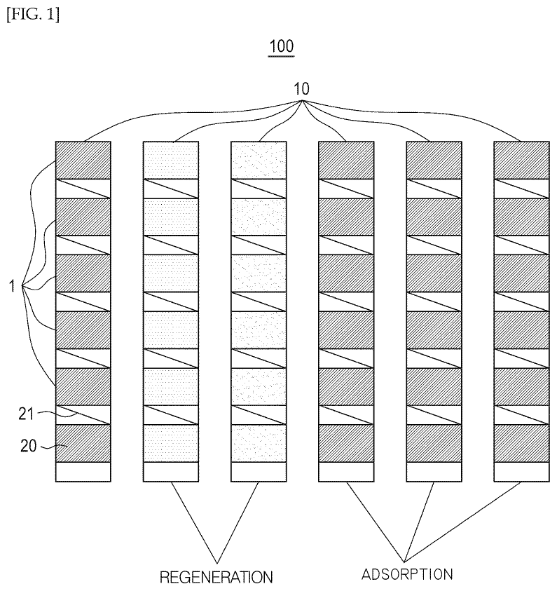

Hereinafter, the configuration, functions and operating method of a continuous direct air capture system with a low differential pressure according to an embodiment is described. FIG. 1 is a front schematic view of an adsorption unit according to an embodiment of the present disclosure.

A continuous direct air capture system with a low differential pressure according to an embodiment of the present disclosure is configured to include multiple adsorption units 10. An adsorption unit 10 includes a housing that has an inlet part 2 for introducing external air and an outlet part 3 for discharging carbon dioxide-removed air, and a plurality of adsorbent modules 20 installed within the housing and composed of carbon dioxide adsorbents.

Further, in the adsorption units 10, the adsorbent modules 20 are stacked with a predetermined spacing, and a guide plate 21 is included, connecting one corner of one adsorbent module 20 to the opposite corner of another adsorbent module 20. Therefore, inlet gas contacts the adsorbent module 20 perpendicularly to its planar surface by a guide plate 21, allowing the gas to pass through the adsorbent module 20 in its thickness direction.

These adsorption units 10 are connected in plurality. The adsorption units 10 are configured to sequentially undergo adsorption mode and regeneration mode and to always operate in adsorption mode in a set number of adsorption units 10. The ratios of adsorption, regeneration, and the number of units may be set to optimize the total amount adsorbents required, the time ratio of regeneration and adsorption, equipment cost and operating cost.

Further, according to an embodiment of the present disclosure, it is designed so that the inlet air passes through the adsorbent modules 20 uniformly (with uniform differential pressure) in adsorption mode, and the regenerated streams pass through the adsorbent modules 20 uniformly in regeneration mode.

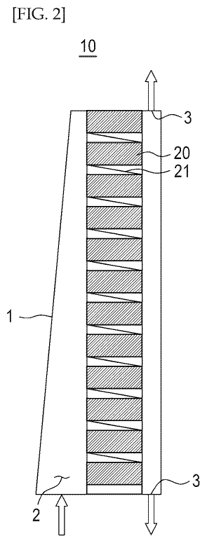

FIG. 2 is a configuration view of an adsorption unit in a tray according to an embodiment of the present disclosure.

As shown in FIG. 2, it can be seen that an adsorption unit 10 is located within a tray 1 and the tray is configured with an inclined inlet so that the width gradually decreases from an inlet part 2 according to the gas flow.

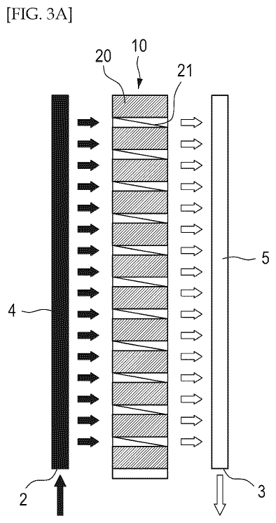

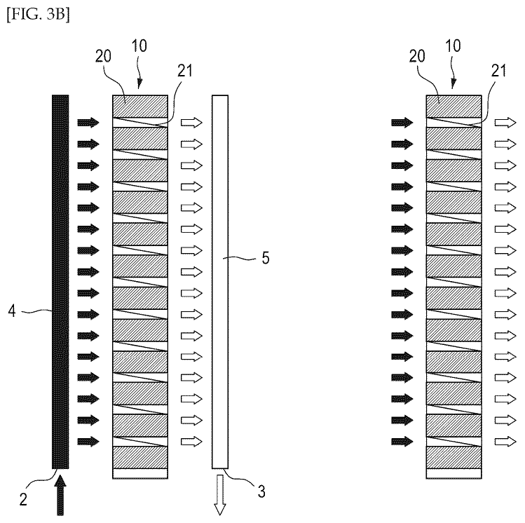

FIG. 3A and FIG. 3B are configuration views of an adsorption unit applied with a header according to an embodiment of the present disclosure.

An inlet header 4 and an exhausting header 5 may be installed to allow gas to pass through each adsorbent module 20 uniformly (with uniform differential pressure). Therefore, gas is introduced into the inlet header 4 and uniformly supplied to the adsorbent modules through outlet holes of the inlet header 4.

According to an embodiment of the present disclosure, this header structure is not applied to an adsorption unit 10 operating in adsorption mode but is installed only in the regeneration zone. When the adsorption unit 10 is located in the regeneration zone, the regenerated streams are passed through the adsorbent modules 20 uniformly via the headers, thereby enabling the adsorbent modules 20 to be regenerated at a uniform rate.

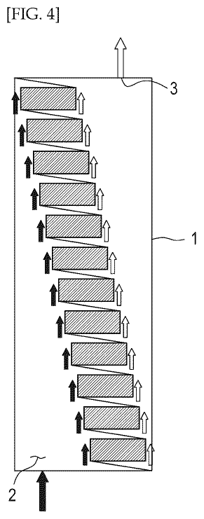

FIG. 4 is a configuration view of a step-type adsorption unit according to an embodiment of the present disclosure. As shown in FIG. 4, it can be seen that, in the adsorption unit, adsorbent modules are stacked in a stepped manner and a guide plate is included, connecting one corner of an adsorbent module to the opposite corner of another adsorbent modules located below the adsorbent module.

In addition, as shown in FIG. 4 in the embodiment of the present disclosure, the adsorbent modules 20 are stacked in a stepped manner so that the width decreases according to fluid flow in the inlet zone where regeneration streams are introduced during regeneration mode, and the regeneration streams pass through the adsorbent modules 20 uniformly, thereby enabling the adsorbent modules 20 to be regenerated at a uniform rate.

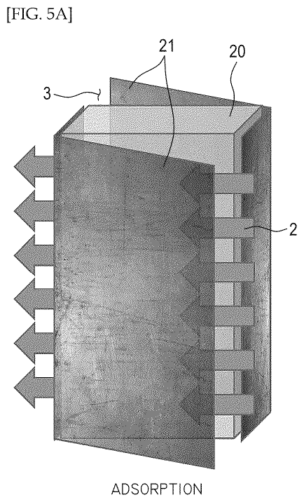

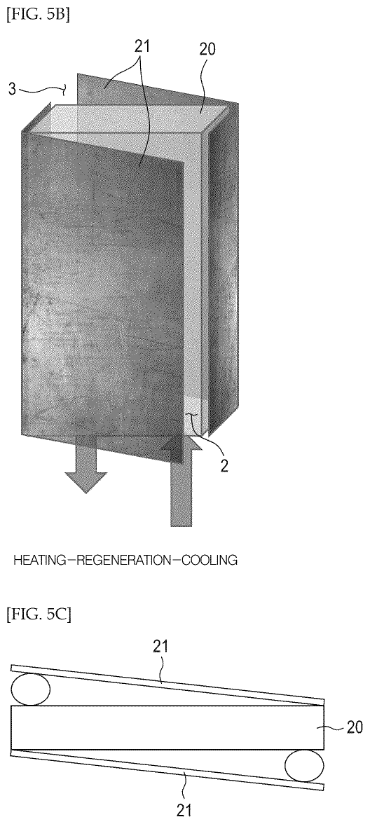

FIG. 5A to FIG. 5C are perspective and plan views of a tower-type adsorption unit according to an embodiment of the present disclosure. As shown in FIG. 5A to 5C, it can be seen that an adsorption unit 10 according to an embodiment of the present disclosure is configured in a tower shape where the width is smaller than the length and height. In addition, plates 21 is included connecting one corner of the front side of one adsorption unit 10 to the opposite corner of the back side of another adsorption unit.

Hereinafter, an operating method of the aforementioned continuous direct air capture system with a low differential pressure is described in more detail.

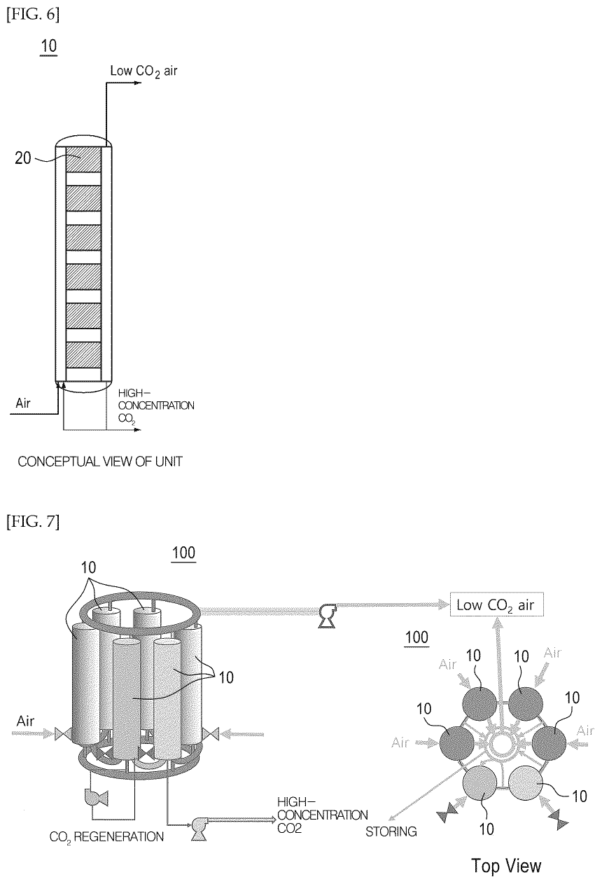

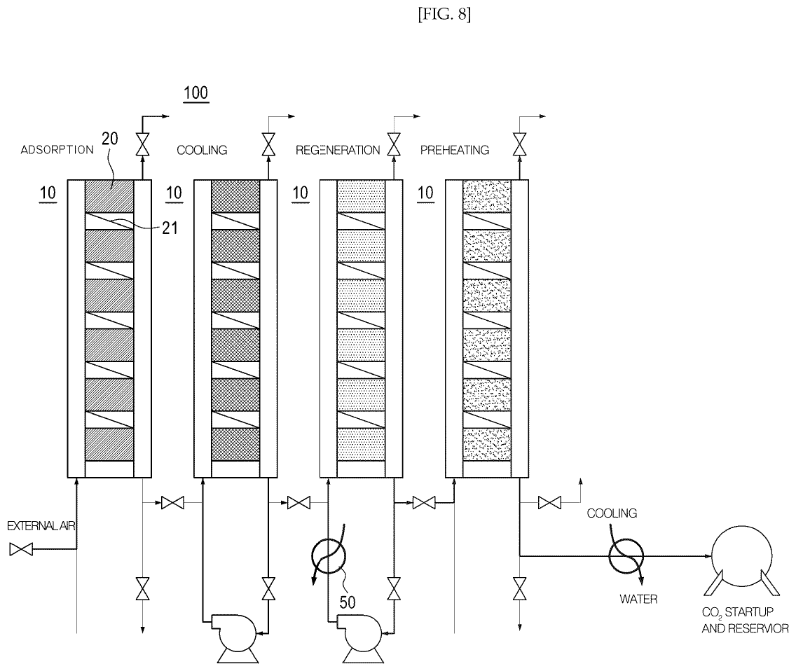

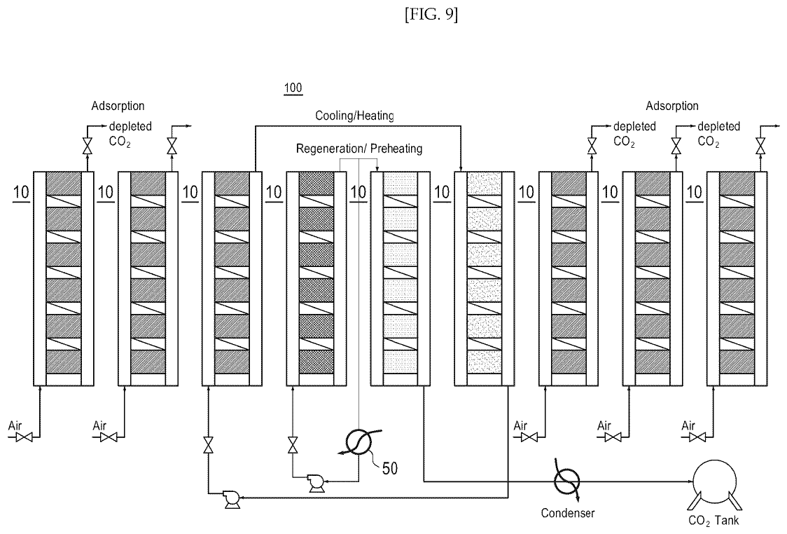

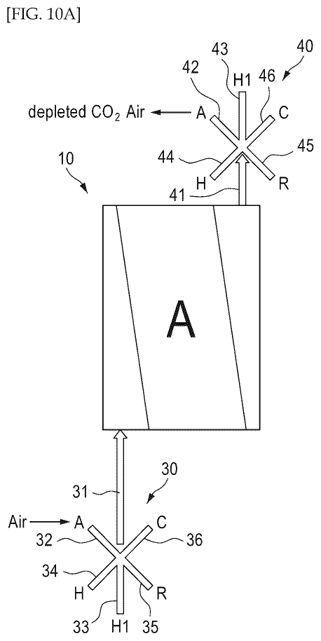

FIG. 6 is a conceptual view of an adsorption unit according to an embodiment of the present disclosure. FIG. 7 is a perspective view and a plan view of a continuous direct air capture system with a low differential pressure according to an embodiment of the present disclosure. FIG. 8 is a configuration view of a continuous direct air capture system with a low differential pressure according to an embodiment of the present disclosure. FIG. 9 is a configuration view of an operating method of a continuous direct air capture system with a low differential pressure according to an embodiment of the present disclosure.

As mentioned above, an adsorption unit 10 according to an embodiment of the present disclosure is connected in plurality. The adsorption unit 10 sequentially undergoes adsorption mode and regeneration mode and always operates in adsorption mode in a set number of adsorption units

More specifically, the adsorption unit 10 undergoes sequential cyclic process of adsorption mode, temperature increase mode, heating mode, regeneration mode, cooling mode, and adsorption mode.

Additionally, a suction valve 30 is provided at an inlet part 2 to introduce gas according to the mode. An outlet valve 40 is provided an outlet part 3 to exhaust gas passed through adsorbent modules according to the mode.

Furthermore, a controller controls the suction valve 30 and the outlet valve 40 according to adsorption mode, temperature increase mode, heating mode, regeneration mode, and cooling mode.

According to an embodiment of the present disclosure, the suction valve 30 and the outlet valve 40 are 5-ways valves.

The suction valve 30 includes a suction connection port 31 connected to the inlet part 2 of an adsorption unit 10, an air inlet port 32 for introducing air in adsorption mode, a preheating inlet port 33 for introducing preheated gas in temperature increase mode, a heating inlet port 34 for introducing heated gas in heating mode, a regeneration inlet port 35 for introducing regenerated gas, and a cooling inlet port 36 for introducing coolant in cooling mode. Basically, a suction connection port 31 is always open. The air inlet port 32 opens only in adsorption mode, the preheating inlet port 33 opens only in temperature increase mode, the heating inlet port 34 opens only in heating mode, the regeneration inlet port 35 opens only in regeneration mode, and the cooling inlet port 36 opens only in cooling mode

On the other hand, the outlet valve 40 is configured to include an outlet connection port 41 connected to the outlet part 3 of the adsorption unit 10, an air outlet port 42 for discharging air passed through the adsorption unit 10 in adsorption mode, a preheating outlet port 43 for discharging heated gas that has passed through an adsorption unit in temperature increase mode, a heating outlet port 44 for discharging heated gas that has passed through an adsorption unit in heating mode, a regeneration outlet port 45 for discharging regenerated gas that has passed through an adsorption unit in regeneration mode, and a cooling outlet port 46 for discharging coolant passed through an adsorption unit. Basically, an outlet connection port 41 is always open. The air outlet port 42 opens only in adsorption mode, the preheating outlet port 43 opens only in temperature increase mode, the heating inlet port 44 opens only in heating mode, the regeneration outlet port 45 opens only in regeneration mode, and the cooling inlet port 46 opens only in cooling mode.

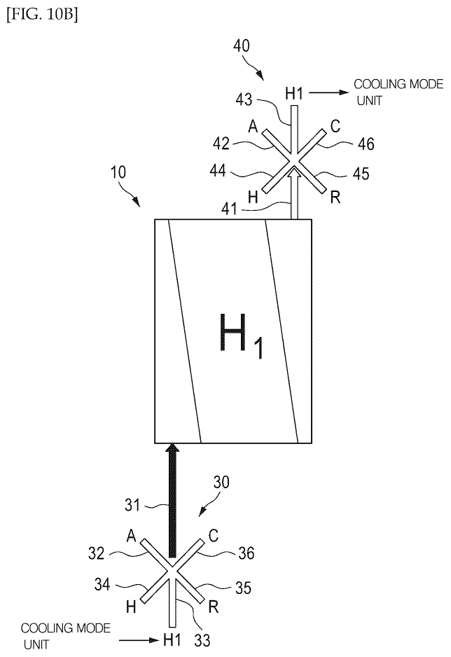

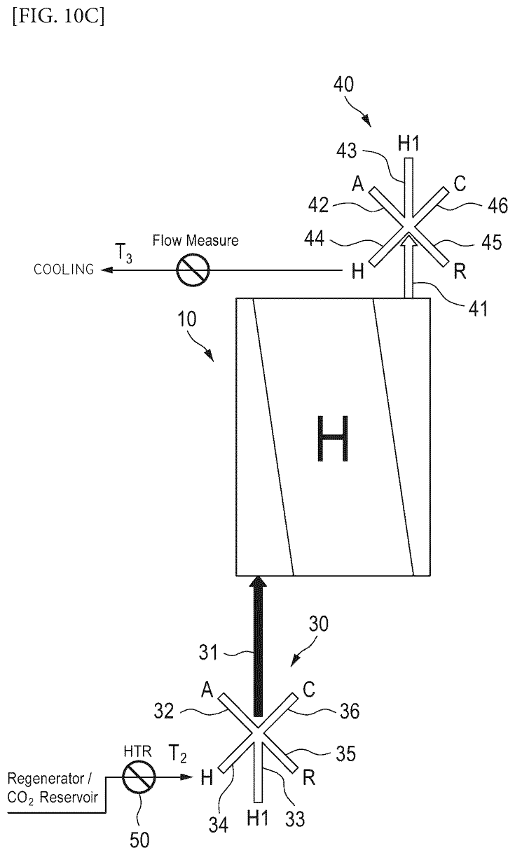

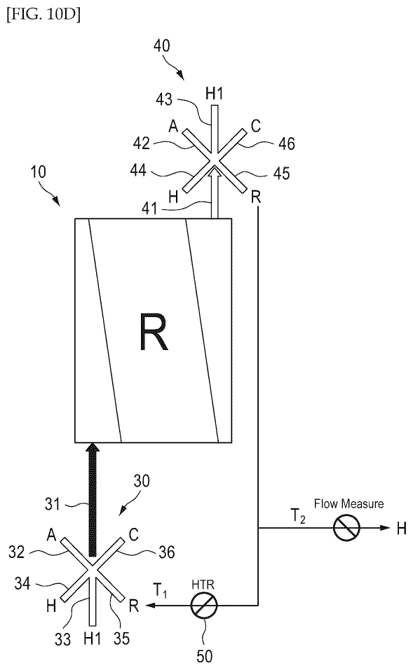

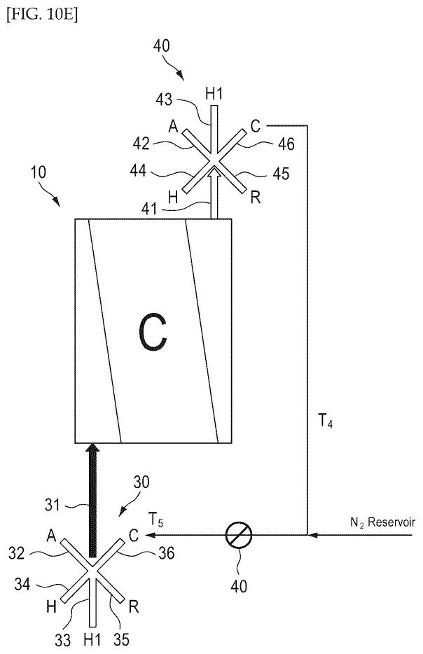

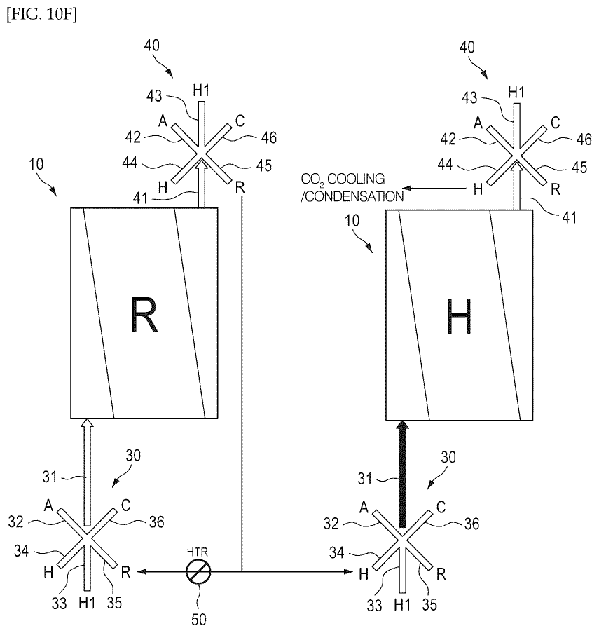

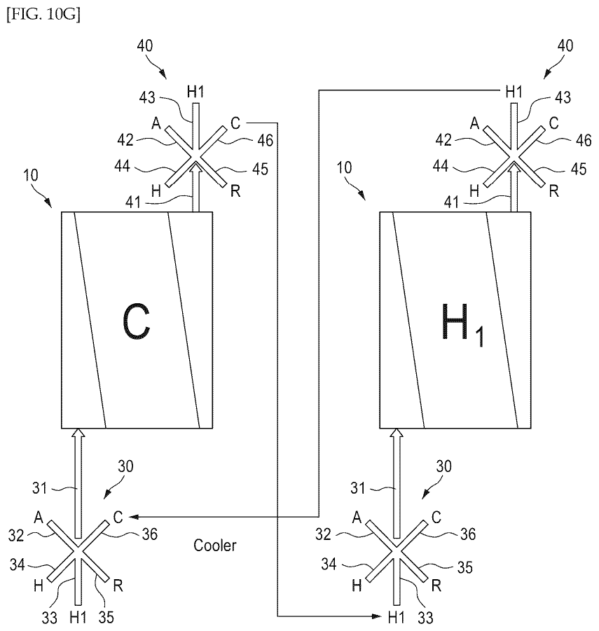

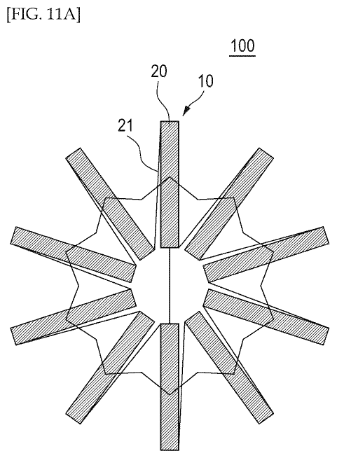

FIG. 10A is a configuration view of an adsorption unit in adsorption mode A according to an embodiment of the present disclosure. In adsorption mode, an adsorption inlet port 32 and an adsorption outlet port 42 are opened, allowing air to be introduced through the adsorption inlet port 32, pass through the adsorbent module of an adsorption unit 10 through a connection port 31, adsorb carbon dioxide in the air, and discharge carbon dioxide-controlled air through an outlet connection port 41 and adsorption outlet port 42.

FIG. 10B is a configuration view of an adsorption unit in temperature increase mode H1 according to an embodiment of the present disclosure. In temperature increase mode, a preheating inlet port 33 and a preheating outlet port 43 are opened. As will be described later, gas exhausted from a cooling outlet port 40 is introduced through the preheating inlet port 33 and passes through an adsorbent module 20 of an adsorption unit 10 via a connection port 31, heating the adsorbent module 20, and is then exhausted through an outlet connection port 41 and the preheating outlet port 43 before being introduced into a cooling outlet port 36 of the adsorption unit 10 in cooling mode.

FIG. 10C is a configuration view of an adsorption unit in heating mode H according to an embodiment of the present disclosure. In heating mode, a heating inlet port 34 and a heating outlet port 44 are opened. As will be described later, gas passed through an adsorption unit in generation mode is introduced through the heating inlet port 34. In this case, gas may be heated through a heater 50 to control temperature before being introduced into the heating inlet port 34. Inlet gas passes through an adsorbent module 20, heating the adsorbent module 20 and be then discharged through the heating outlet port 44 of the adsorbent module. In this case. In this case, carbon dioxide enriched gas, passing through the adsorption unit 10 in regeneration mode, passes through the adsorption unit in heating mode, and partially desorbs carbon dioxide in the adsorbent module of the adsorption unit in heating mode. Carbon dioxide enriched gas is exhausted and then cooled and condensed to separate, capture, and store carbon dioxide.

FIG. 10D is a configuration view of an adsorption unit in regeneration mode(R) according to an embodiment of the present disclosure. In regeneration mode, a regeneration inlet port 35 and a regeneration outlet port 45 are opened. Gas heated by a heater 50 is introduced through the regeneration inlet port 35. Inlet heated gas passes through an adsorbent module 20, regenerating the adsorbent module 20 and then being discharged through the regeneration outlet port 45. A portion of discharged gas is supplied to an adsorption unit 10 in heating mode and the remaining is reheated by the heater 50, being introduced through the regeneration inlet port 35 again.

FIG. 10F is a connection configuration view of an adsorption unit in regeneration mode R and an adsorption unit in heating mode H. A shown in FIG. 10F, carbon dioxide enriched gas, passing through an adsorption unit 10 in regeneration mode, passes through the adsorption unit in heating mode, partially desorb carbon dioxide in the adsorbent module of the adsorption unit in heating mode. Caron enriched gas is exhausted and then cooled and condensed to separate, capture and store carbon dioxide.

FIG. 10E is a configuration view of an adsorption unit in cooling mode C according to an embodiment of the present disclosure. FIG. 10G is a connection configuration view of an adsorption unit in cooling mode C and an adsorption unit in temperature increase mode H1.

According to an embodiment of the present disclosure, as shown in FIG. 10E, a cooling inlet port 36 and a cooling outlet port 46 are opened. Gas cooled to a set temperature by a cooler 60 is introduced through the cooling inlet port 36, cooling an adsorbent module 20 before undergoing adsorption mode.

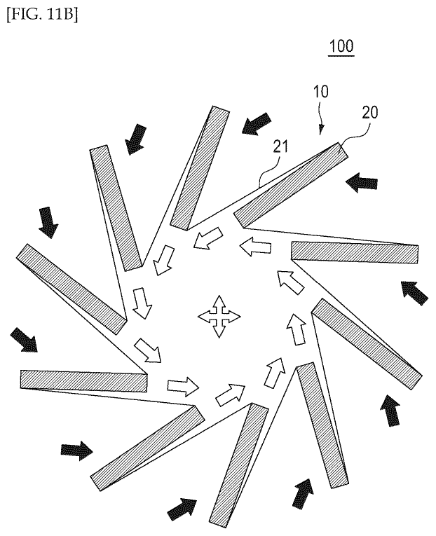

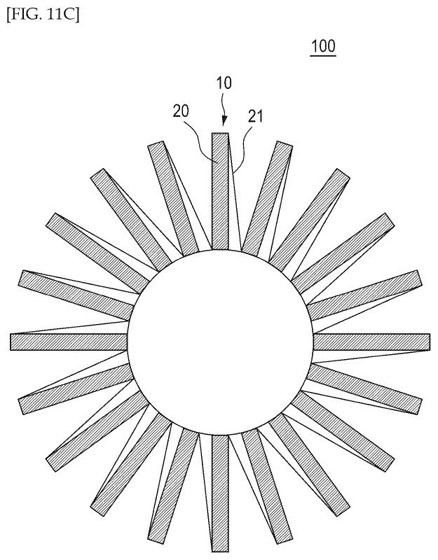

Further, as shown in FIG. 10G, according to an embodiment of the present disclosure, it can be seen that an adsorption unit 10 in cooling mode and an adsorption unit 10 in temperature increase mode are interconnected. In other word, gas discharged through a cooling outlet port 46 is introduced into a preheating inlet port 33. Gas discharged to a preheating outlet port 43 is introduced into a cooling inlet port 36 via a cooler 60 as needed. FIG. 11A to FIG. 11C are plan views of a tower type continuous direct air capture system with a low differential pressure according to an embodiment of the present disclosure. As shown in FIG. 11A to FIG. 11C, an adsorption unit 10 according to an embodiment of the present disclosure may have a tower-shaped structure, where the width is smaller than the height and length, and a guide plate 21 may be installed connecting one corner of the front side of an adsorption unit 10 to the opposite corner of the back side of another adsorption unit 10.

Further, the configuration and method of the embodiments as described above are not restrictively applied to the aforementioned apparatus and method. The whole or part of the respective embodiments may be selectively combined so as to make various modifications of the embodiments.

### FIGURE REFERENCE NUMBERS

1: tray
2: inlet part
3: outlet part
4: inlet header
5: exhausting header
10: adsorption unit
20: adsorbent module
21: guide plate
30: suction valve
31: suction connection port
32: air inlet port
33: preheating inlet port
34: heating inlet port
35: regeneration inlet port
36: cooling inlet port
40: outlet valve
41: outlet connection port
42: air outlet port
43: preheating outlet port
44: heating outlet port
45: regeneration outlet port
46: cooling outlet port
50: heater
60: cooler
100: continuous direct air capture system with a low differential pressure

1. As a direct air capture system, a continuous direct air capture system with a low differential pressure comprising:
an adsorption unit including a housing having an inlet part for introducing external air and an outlet part for discharging carbon dioxide-removed air, and a plurality of adsorbent modules installed within the housing and composed of carbon dioxide adsorbents, wherein
the adsorption unit is connected in plurality, and the adsorption unit sequentially undergoes adsorption mode and regeneration mode and always operates in adsorption mode in a set number of adsorption units;
an suction valve provided at the inlet part for introducing external air, and an outlet valve provided at the outlet part for exhausting gas passed through the adsorbent modules; and
a controller for controlling the suction valve and the outlet valve according to adsorption mode and regeneration mode, respectively.

2. As a direct air capture system, a continuous direct air capture system with a low differential pressure comprising:
an adsorption unit including a housing having an inlet part for introducing external air and an outlet part for discharging carbon dioxide-removed air, and a plurality of adsorbent modules installed within the housing and composed of carbon dioxide adsorbents, wherein
the adsorption unit is configured in a tower shape where the width is smaller than the length and height; and
a plurality of adsorption units are radially arranged around a central circle.

3. The continuous direct air capture system with a low differential pressure according to claim 1, wherein
the adsorption unit undergoes sequential cyclic process of adsorption mode, temperature increase mode, heating mode, regeneration mode, cooling mode, and adsorption mode.

4. The continuous direct air capture system with a low differential pressure according to claim 3, wherein
the suction valve and the outlet valve are 5-ways valves.

5. The continuous direct air capture system with a low differential pressure according to claim 4, wherein
the suction valve includes a suction connection port connected to the inlet part of the adsorption unit, an air inlet port for introducing air in adsorption mode, a preheating inlet port for introducing preheated gas in temperature increase mode, a heating inlet port for introducing heated gas in heating mode, a regeneration inlet port for introducing regenerated gas, and a cooling inlet port for introducing coolant in cooling mode.

6. The continuous direct air capture system with a low differential pressure according to claim 5, wherein
the outlet valve includes an outlet connection port connected to the outlet part of the adsorption unit, an air outlet port for discharging air passed through an adsorption unit in adsorption mode, a preheating outlet port for discharging heated gas that has passed through an adsorption unit in temperature increase mode, a heating outlet port for discharging heated gas that has passed through an adsorption unit in heating mode, a regeneration outlet port for discharging regenerated gas that has passed through an adsorption unit in regeneration mode, and a cooling outlet port for discharging coolant passed through an adsorption unit.

7. The continuous direct air capture system with a low differential pressure according to claim 6, wherein
coolant discharged through the cooling outlet port is introduced into the preheating inlet port, and coolant discharged to the preheating outlet port is introduced into the cooling inlet port through a cooler.

8. The continuous direct air capture system with a low differential pressure according to claim 7, wherein
carbon dioxide enriched gas passed through the adsorption unit in regeneration mode is cooled, condensed, and stored.

9. The continuous direct air capture system with a low differential pressure according to claim 8, wherein
gas heated by a heater is introduced into the regeneration inlet port and gas that has passed through the adsorption unit and regenerated a carbon dioxide adsorbent is discharged and then a portion of the gas is heated by the heater and circulated, while the remaining portion is introduced into the heating inlet port to heat the adsorption unit operating in heating mode, and then discharged to the heating outlet port.

10. The continuous direct air capture system with a low differential pressure according to claim 9, wherein
carbon dioxide enriched gas passed the adsorption units in heating mode is cooled, condensed, and stored.

11. The continuous direct air capture system with a low differential pressure according to claim 1, wherein
in a regeneration zone, heated regeneration streams are uniformly distributed to the adsorbent module through an inlet header.

12. The continuous direct air capture system with a low differential pressure according to claim 11, wherein
in the regeneration zone, the adsorption unit is located within a tray,
in the adsorption unit, the adsorbent modules are stacked in a stepped manner and a guide plate is included, connecting one corner of an adsorbent module to the opposite corner of another adsorbent module located below the adsorbent module.

13. The continuous direct air capture system with a low differential pressure according to claim 12, wherein
the adsorbent modules are stacked in a stepped manner in an inlet zone where the regeneration stream is introduce during regeneration mode, with the width decreasing in direction of fluid flow.

14. The continuous direct air capture system with a low differential pressure according to claim 1, wherein
the adsorption unit has a tower-shaped structure where the width is smaller than the length and height, and
the guide plate is included connecting one corner of the front side of the one adsorption unit to the opposite corner of the back side of another adsorption units.

15. The continuous direct air capture system with a low differential pressure according to claim 2, wherein the adsorption unit undergoes sequential cyclic process of adsorption mode, temperature increase mode, heating mode, regeneration mode, cooling mode, and adsorption mode.

16. The continuous direct air capture system with a low differential pressure according to claim 2, wherein in a regeneration zone, heated regeneration streams are uniformly distributed to the adsorbent module through an inlet header.

17. The continuous direct air capture system with a low differential pressure according to claim 2, wherein the adsorption unit has a tower-shaped structure where the width is smaller than the length and height, and
wherein the guide plate is included connecting one corner of the front side of the one adsorption unit to the opposite corner of the back side of another adsorption units.
